(19) United States
(12) Patent Application Publication
(10) Pub. No.: US 2004/0239993 A1
(43) Pub. Date: Dec. 2, 2004

(54) Image processing unit and image forming apparatus

(76) Inventor: Ichiro Urata, Tokyo (JP)

Correspondence Address: TAKEUCHI & TAKEUCHI, Suite 310, 1700 Diagonal Road, Alexandria, VA, 22314, US

(21) Appl. No.: 10/854,675

(22) Filed: May 27, 2004

(30) Foreign Application Priority Data
May 29, 2003 (JP) 2003-151895

(51) Int. Cl. G06F 15/00

(52) U.S. Cl. 358/1.16

(57) ABSTRACT

An image forming apparatus comprises a data quantity determining section (4-1) for determining a data quantity of image information based on the received image attribute information; a memory section area determining section (4-2) for determining a necessary memory section area necessary for processing raster data for the image data based on a determination result of the data quantity determining section; and a memory state setting section (4-3) for setting the memory sections (3-1, 3-2, 3-3) at either active or inactive state based on a determination result of the memory section area determining section (4-2).

### BACKGROUND OF THE INVENTION

1. Field of the Invention

The present invention relates to an image processing unit useful for a printer or facsimile and an image forming apparatus having an image processing apparatus.

2. Description of the Related Art

In order to meet the demands for high resolution, high degrees of gradation or gradient, and/or large printing medium, an image forming apparatus, such as a printer or facsimile, has a high speed, large capacity memory. Usually, a large number of synchronous dynamic random access memories (SDRAMs) are used for the large capacity memory. Consequently, the ratio of power consumption by the memory to that of the entire apparatus becomes large. For this reason, all of the SDRAMs are made inactive in the stand-by state of the apparatus or the minimum SDRAMs necessary for image processing always are kept active and the other SDRAMs are made active as needed. However, such a technology saves little power because most of the memories are used for the image processing.

### SUMMARY OF THE INVENTION

Accordingly, it is an object of the invention to provide an image processing apparatus having low power consumption by a simple control means and an image forming apparatus having such an image processing apparatus.

According to the invention there is provided an Image processing apparatus comprising at least one memory section that independently is set either active or inactive state; a date quantity determining section for determining a data quantity of image data from received image attribute information; a memory section area determining section for determining a memory section area based on the determination result of the data quantity determining section; and a memory state setting section for setting the memory sections at either the active or inactive state based on the determination result of the memory section area determining section.

### BRIEF DESCRIPTION OF THE DRAWINGS

FIG. 1 is a block diagram of an image processing apparatus according to the first embodiment of the invention;

FIG. 2 is a flow chart showing the operation of the image process apparatus;

FIG. 3 is a diagram of an image data structure;

FIG. 4 is a flow chart showing an image data process;

FIG. 5 is a diagram showing the power consumption by the image processing apparatus according to the first embodiment;

FIG. 6 is a block diagram of an image processing apparatus according to the second embodiment of the invention;

FIG. 7 is a flow chart of the operation of the image processing apparatus of FIG. 6; and

FIG. 8 is a diagram of the power consumption of the image processing apparatus of FIG. 6.

### DESCRIPTION OF THE PREFERRED EMBODIMENTS

First Embodiment

The control unit of this embodiment comprises a data quantity determination section, a memory area determination section, and a memory condition setting section. Based on the image attribute information received from the preceding device, it determines the total data quantity of the image data to be processed and keeps active only the minimum memory portion necessary for the total data quantity. Thus, it minimizes the power consumption.

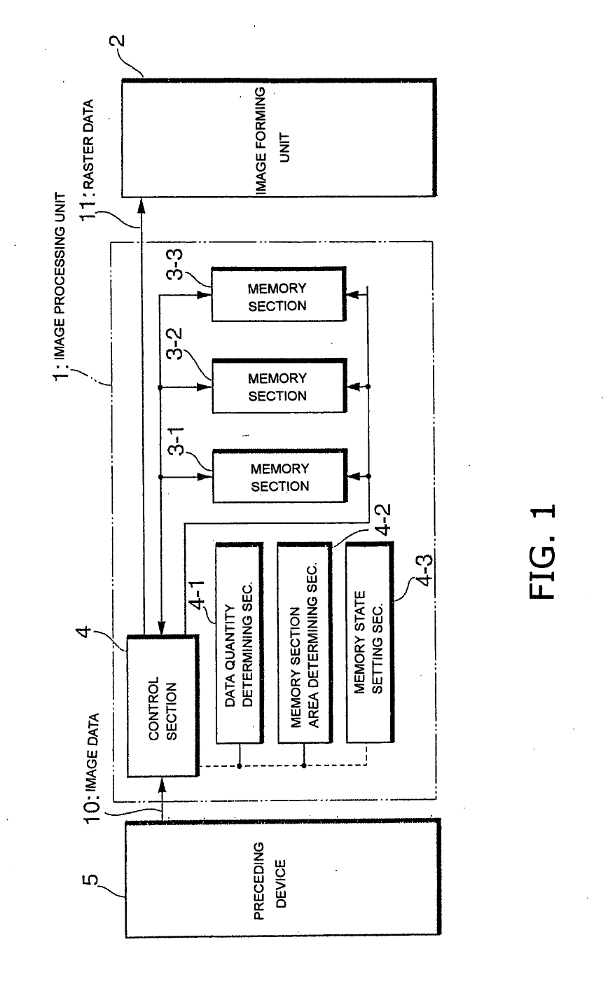

In FIG. 1, an image forming apparatus 100 comprises an image processing unit 1 and an image forming unit 2. The image processing unit 1 receives an image data from the preceding device 5 and performs an image process to generate and send a raster data to the image forming unit 2. It comprises three, for example, memory section 3-1, 3-2, and 3-3, and a control section 4. The preceding device 5 is an image data generator such as a personal computer or scanner. The raster data is a data group that the gradation data of each pixel to be reproduced on the paper is arranged at the corresponding position on a virtual plane provided on the memory corresponding to a sheet of paper.

The memory sections 3-1, 3-2, and 3-3 are settable in an active or inactive state independently. An example is SDRAM. The active state allows writing and reading and consumes a large amount of power. The inactive state allows neither writing nor reading but keeps data and consumes a small amount of power, which normally is called “power down mode.” The active/inactive state is switched by a clock enable signal (hereinafter “CKE”) sent by the control section 4.

The control section 4 controls the entire image processing unit 1. It performs transformation and expansion processes of image data received from the preceding device 5 to generate raster data on the memory sections 3-1, 3-2, and 3-3 and send them to the image forming unit 2. It comprises a data quantity determination section 4-1, a memory area determination section 4-2, and a memory condition setting section 4-3.

The data quantity determination section 4-1 is a control section for determining the total data quantity of image data from the image attribute information contained in the image data received. The memory area determination section 4-2 is a control section for determining a memory area necessary for processing the image data into raster data based on the determination result of the data quantity determination section 4-1. The memory condition setting section 4-3 is a control section for sending CKE signals to a plurality of the memory sections 3-1, 3-2, and 3-3 to set them at either active or inactive state.

Usually, these control sections are made as a computer program for controlling the control section 4 and stored in a memory (not shown) as a unit. The control sections can be stored on a recording medium that a computer can read out. The relationship in software between the control sections and the image processing unit 1 will be described later. The image forming unit 2 receives the raster data from the control section 4 and reproduces the image on paper for outputting.

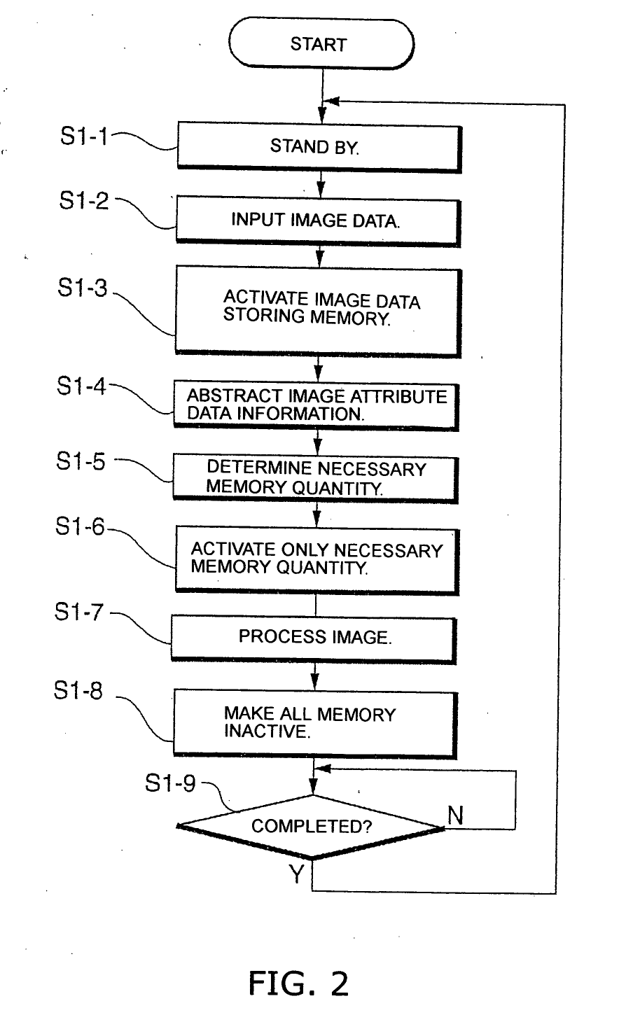

The operation of the image processing unit 1 according to the first embodiment will now be described with reference to FIG. 2.

In Step S1-1, the image processing unit 1 stands by for an image data 10 from the preceding device 5. Under this condition, the memory sections 3-1, 3-2, and 3-3 receives low level CKE signals and are held at the inactive state.

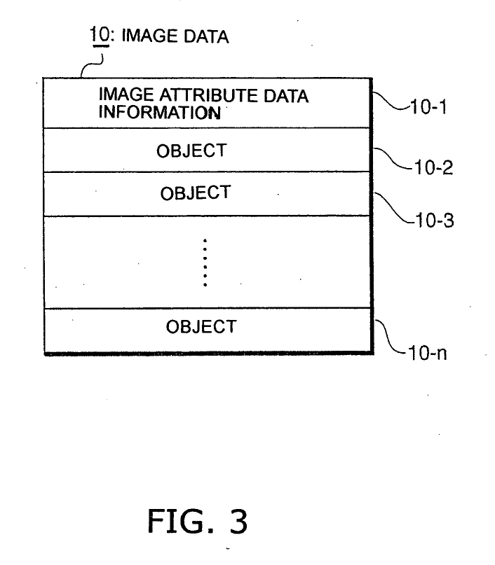

In Step S1-2, the preceding device 5 sends an image data to the image processing unit 1 and the control section 4 receives the image data 10 via a communications section (not shown). As shown in FIG. 3, the image data 10 is composed of an image attribute data 10-1 and objects 10-2, . . . 10-n. The image attribute data 10-1 contains information useful for determining the total data quantity of image data such as page description language, color, resolution, gradient, paper size, and duplicate printing designations of the image data. The objects 10-2, . . . 10-n, which represent images, are three primary colors (RGB) data.

In Step S1-3, the control section 4 sends to the memory section 3-1 a high level CKE signal for securing a memory area necessary for storing the image data 10. Upon reception of the high level CKE signal, the memory area 3-1 switches to the active state and stores the image data. At this point, the objects 10-2, . . . 10-n are not subjected to image processing so that the data quantity is so small that the necessary memory area is small.

In Step S1-4, the control section 4 abstracts only the image attribute data 10-1 from the image data 10.

In Step S1-5, the control section 4 determines the memory capacity necessary for image processing based on the image attribute data 10-1. The necessary memory capacity is determined from the sum of data quantities of the raster data produced by the image processing, the intermediate data produced by the raster data generation, and the continuously fed paper quantity corresponding to the paper running route within the image forming unit 2.

The image processing contents vary with the page description language designation so that the relation between the page description language and the intermediate file capacity is tabulated in advance. Thus, the data quantity of the intermediate data is determined instantly based on the page description language designation stored in the image attribute data 10-1. The data quantity of raster data is calculated readily from the product of the output color number of a page, the number of printing dots in a single color and a page, and the data quantity of a dot. Also, it is necessary to provide the data quantity equal to the product of the number of continuously fed paper sheets corresponding to the paper running route within the image forming unit 2 and the data quantity of raster data. The number of printing dots for the single color and the single page is found from the product of the resolution designation and the paper size designation. The necessary memory capacity is determined from the sum of these data quantities.

In Step S1-6, based on the memory capacity determined in Step S1-5, the control section 4 determines the area of the memory section necessary for the image processing and sends to the memory area a high level CKE signal for securing the memory area. Now, it is assumed that the necessary memory capacity is so small that the memory section 3-1 alone is sufficient. The other memory sections 3-2 and 3-3 are held at the inactive state.

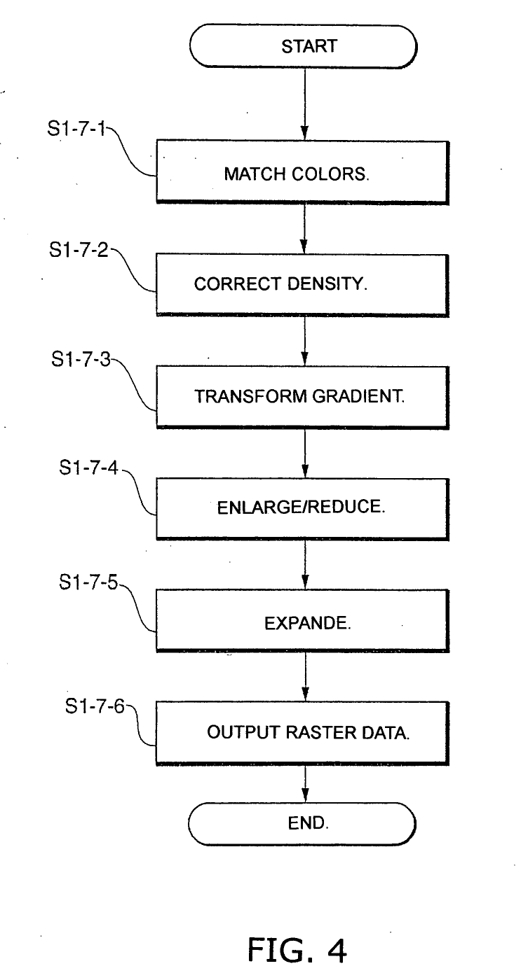

In Step S1-7, the control section 4 employs the memory section 3-1 activated in Step S1-6 to process the image data. This process, which is the same as the conventional image process, will be described with reference to FIG. 4.

In Step S1-7-1, the control section 4 performs a color matching process of the received RGB data for transformation into a CMYK-1 data (reproduced in four colors; cyan, Magenta, Yellow, and Black) for each object.

In Step S1-7-2, the control section 4 performs a density correction of the CMYK-1 data corresponding to the printing output characteristics of the image forming unit 2 for transformation into a CMYK-2 data.

In Step S1-7-3, the control section 4 performs a gradient transformation of the CMYK-2 data into a CMYK-3 data according to the gradient designation of the image attribute data 10-1.

In Step S1-7-4, the control section 4 performs an enlargement/reduction transformation of the CMYK-3 data into a CMYK-4 data according to the paper size designation of the image attribute data 10-1.

In Step S1-7-5, the control section 4 performs an expansion process of the CMYK-4 data.

In Step S1-7-6, the control section 4 outputs a raster data and ends the image processing flow. The flow is returned FIG. 2.

In Step S1-8, the control section 4 sends all raster data to the image forming unit 2 and then low level CKE signals to all the memory sections, bringing them into the inactive state.

In Step S1-9, after all the processes are completed, the flow returns to Step S1-1 where the control section 4 stands by for receiving a subsequent image signal.

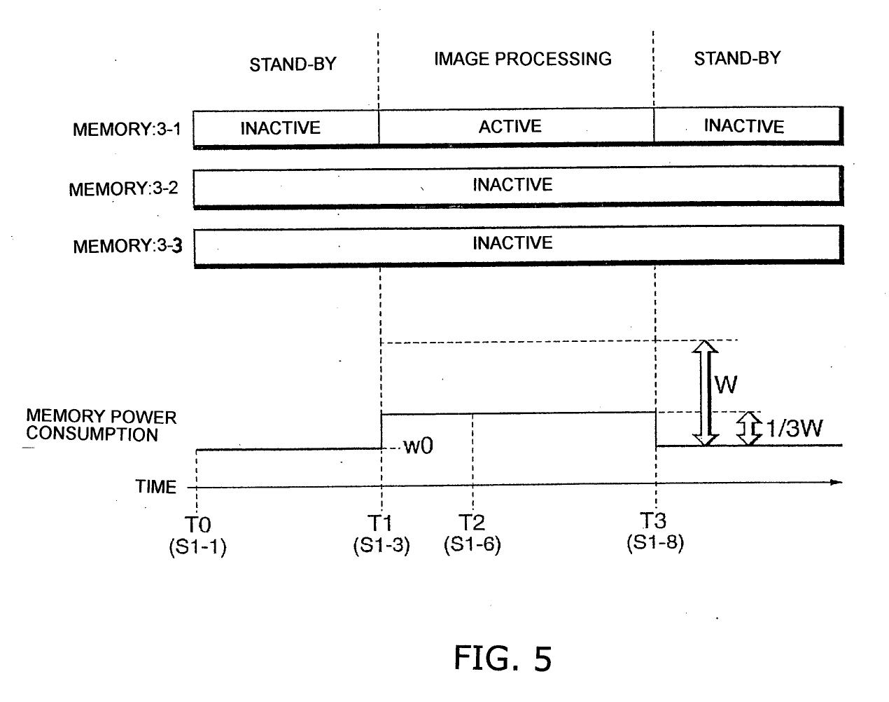

The relation between the operation of the image processing unit 1 and the memory power consumption will be described with reference to FIG. 5, wherein the state descriptions, the states of the memory sections 3-1, 3-2, and 3-3, and the memory power consumption are described along the vertical axis and the common time and the steps in FIG. 2 are described along the horizontal axis.

At a time T0, the image processing unit 1 stands by for receiving an image data 10 from the preceding device 5. This is the state of step S1-1. Under this condition, the memory sections 3-1 to 3-3 receives a low level CKE signal and remains at the inactive state. Consequently, the memory power consumption of the image processing unit 1 is W0 watts.

At a time T1, the image processing unit 1 receives an image data, and the control section 4 sends to the memory section 3-1 a high level CKE signal for securing the necessary memory area for the image data 10. This is the state of Step S1-3. The memory section 3-1 receives the high level CKE signal and switches to the active state. The memory sections 3-2 and 3-3, however, keeps their inactive state. Consequently, the increased memory power consumption is only ⅓ W watts in contrast to the conventional power consumption increase of W watts where all the memory sections switch to the active state in the conventional image process unit.

At a time T2, the control section 4 determines the memory area necessary for the image process based on the memory capacity determined in the step S1-5 and sends to the memory section a high level CKE signal for securing the necessary memory area. This is the state of Step S1-6. According to the assumption in the step S1-6, the necessary memory capacity is so small that the memory section 3-1 alone is sufficient and the other memory sections 3-2 and 3-3 are kept inactive. Consequently, the memory power consumption remains (W0+⅓ W) watts.

At a time T3, after sending all raster data to the image forming unit 2, the control section 4 sends to all the memory sections a low level CKE signal, bringing them into the inactive state. This is the state of Step S1-8. Since the memory section 3-1 is switched to the inactive state, the memory power consumption becomes W0 watts, and the unit stands by for receiving a subsequent image signal.

The relation between the data quantity determination section 4-1, the memory area determination section 4-2, and the memory state setting section 4-3 and the embodiment.

The data quantity determination section 4-1 determines the total data quantity of image data from the received image attribute information and corresponds to a module of the step S4 wherein the control section 4 abstracts only the image attribute data 10-1 from the image data 10 and a module of the step S5 wherein it determines the memory capacity necessary for the image process from the image attribute data 10-1.

Based on the determination result of the data quantity determination section 4-1, the memory area determination section 4-2 determines the memory area necessary for processing the image data into raster data and corresponds to a module of the step S1-6 wherein the control section 4 determines the memory area necessary for processing the image based on the memory capacity determined in the step S1-5.

The memory state setting section 4-3, which sets a plurality of memory sections in either active or inactive state, corresponds to a module of the step S1-3 wherein when the control section 4 receives the image data 10 from the preceding device 5 (Step S1-2), it sends to the memory section 3-1 a high level CKE signal, bringing it to the active state. Also, it corresponds to a module of the step S1-6 wherein, based on the determination result of the memory area determination section 4-2, the memory section 3-1 sends to the predetermined memory section a high level CKE signal, switching it to the action state. Further, it corresponds to a module wherein when the image process is completed (Step S1-8), it sends to all the memory sections a low level CKE signal to switch them to the inactive state.

Alternatively, the number of memory sections may be four or more. The SDRAMs may be replaced by any memories that allows the memory section to hold data until the image forming unit 2 discharges the last sheet of paper. Consequently, if the power supply for a volatile memory section is held so as to make the memory section hold the data until the image forming unit 2 discharges the last paper sheet, the memory section may be used for the invention. The data quantity determination section 4-1, the memory area determination section 4-2, and the memory state setting section 4-3, which take a form of computer program for controlling the control section 4, may be made of circuit blocks that have auxiliary functions of the control section 4.

As has been described above, the control section 4 comprises the data quantity determining section 4-1, the memory area determining section 4-2, and the memory state setting section 4-3 to keep only the minimum memory section in the active state, thus minimizing the power consumption.

Second Embodiment

According to the second embodiment, the power consumption during the image process is reduced even in the apparatus that requires temporally retention of the raster data for a plurality of pages according to the paper running route by providing the control section with a post data holding section for switching a part of the inactive memory section to the active state to hold the raster data that has been sent to the image forming unit and bringing the active memory section into the inactive state.

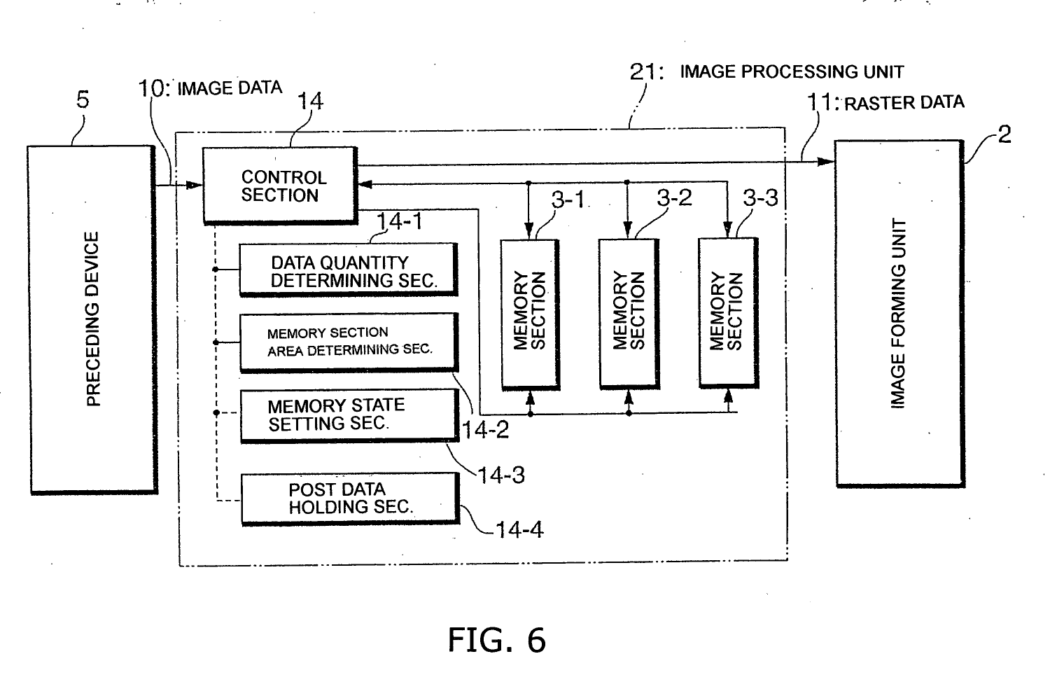

In FIG. 6, the image forming apparatus 200 comprises an image processing unit 21 and an image forming unit 2. Only those that are different from the first embodiment will be described below. The image processing unit 21 receives image data from the preceding device 5 and performs the image process to generate and send raster data to the image forming unit 2. It comprises three, for example, memory sections 3-1, 3-2, and 3-3 and a control section 14. The preceding device 5 is an image data generator such as a personal computer or scanner. The raster data is a data group that the gradient data of each pixel to be reproduced on the paper is arranged at the corresponding position on a virtual plane provided on the memory corresponding to a sheet of paper.

The control section 14 controls the entire image processing unit 21. It performs transforming and expanding processes of image data received from the preceding device 5 to generate raster data in the memory sections 3-1, 3-2, and 3-3 and send them to the image forming unit 2. It comprises a page data quantity determination section 14-1, a memory area determination section 14-2, a memory state setting section 14-3, and a post data holding section.

The page data quantity determination section 14-1 is a control section for determining the data quantity necessary for providing a page of reproduced image from the image attribute information contained in the image data received. The memory area determination section 14-2 is a control section for determining a memory area necessary for processing the data quantity necessary for providing a page of reproduced image into raster data based on the determination result of the data quantity determination section 14-1. The memory state setting section 4-3 is a control section for sending a CKE signal to a plurality of the memory sections 3-1, 3-2, and 3-3 to set them in either active or inactive state. The post data holding section 14-4 sends the raster data for a page of reproduced image to the image forming unit 2 and then switches a part of the inactive memory sections to the active state to hold the sent raster data and switch it again into the inactive state.

Usually, these control sections are made as a computer program for controlling the control section 14 and stored in a memory (not shown) as a unit. The control sections can be stored on a recording medium that a computer can read out. The relationship in software between the control sections and the image processing unit 1 will be described later. The other structural elements are the same as those of the first embodiment and their description will be omitted.

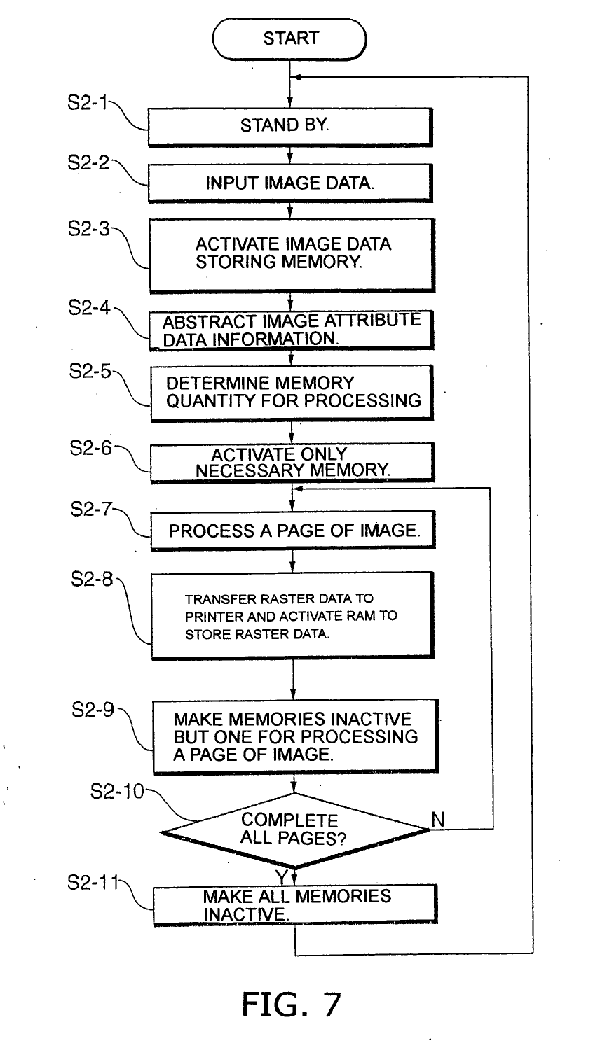

The operation of the image processing unit 21 will be described with reference to FIG. 7.

In Step S2-1, the image processing unit 21 stands by for receiving an image data 10 from the preceding device 5. Under this conditions the memory sections 3-1, 3-2, and 3-3 receive a low level CKE signal and remain in the inactive state.

In Step S2-2, the preceding device 5 sends an image data to the image processing unit 21, and the control section 14 receives the image data via a communications section (not shown). As shown in FIG. 3, the image data 10 is composed of an image attribute data 10-1 and objects 10-2, . . . 10-n. The image attribute data 10-1 contains information useful for determining the total data quantity of image data such as page description language, color, resolution, gradient, paper size, and duplicate printing designations. The objects 10-2, . . . 10-n, which represent an image, are sent as RGB data.

In Step S2-3, the control section 14 sends to the memory section 3-1 a high level CKE signal for securing the memory area necessary for storing the image data 10. The memory section 3-1 receives the high level CKE signal and switches to the active state for storing the image data. At this point, the objects 10-2., 10-n are not processed for image so that the number of data is so small that the necessary memory area is small.

In Step S2-4, the control section 14 abstracts only the image attribute data 10-1 from the image data 10. Unlike the first embodiment, no information about the duplicate printing designation contained in the image attribute data 10-1 is needed in this embodiment.

In Step S2-5, the control section 14 determines the memory capacity necessary for the image process from the image attribute data 10-1. The necessary memory capacity is determined from the sum of the data quantity of raster data of a page of reproduced image resulting from the image process and the data quantity of intermediate data produced in production of the raster data of a page of the reproduced image. The contents of an image process vary with the page description language designation so that the relation between the page description language and the intermediate file capacity is tabulated. Consequently, the data quantity of the intermediate data instantly is determined based on the page description language designation stored in the image attribute data 10-1.

The data quantity of raster data for a page of reproduced image is calculated from the product of the number of output colors, the number of printing dots for a color and a page, and the data quantity for a dot. The number of printing dots is determined from the product of the resolution designation and the paper size designation. The memory quantity necessary for a page of image process is determined from these data quantities.

In Step S2-6, based on the memory capacity determined in the step S2-5, the control section 14 determines the memory area necessary for the image process and sends to the memory section a high level CKE signal for securing the necessary memory area. It is assumed here that the memory capacity necessary for processing a page of raster data is so small that the memory section 3-1 alone is sufficient and the other memory sections 3-2 and 3-3 are kept inactive.

In Step S2-7, the control section 14 employs the activated memory section 3-1 to perform an image process of the image data. This process is the same as that of the first embodiment and its description will be omitted.

In Step S2-8, the control section 14 sends to the image forming unit 2 the raster data for a page of reproduced image (first page). At the same time, it sends to the memory section 3-2 a high level CKE signal for activation to store the raster data for a page of reproduced image (first page) and starts to receive the second page of image data.

In Step S2-9, when the first page of the raster data is stored in the memory section 3-2, the control section 14 sends to the other memory section 3-2 a low level CKE signal for inactivation. Consequently, the raster data for a page of reproduced image is stored in the memory section 3-2 in the power-down mode.

In Step S2-10, if there is a subsequent image data, the control section 14 returns to the step S2-7 and repeats the same flow. When all of the received image data is processed, it goes to Step S2-11. During the repetition of the same process, the raster data of subsequent pages are stored in the memory sections 3-2 and 3-3 one after another. This makes reproduction possible even if the image forming section 2 causes a paper jam.

In Step S2-11, after all of the process are completed, the control section 14 returns to the step S2-1 and stands by for a subsequent image signal.

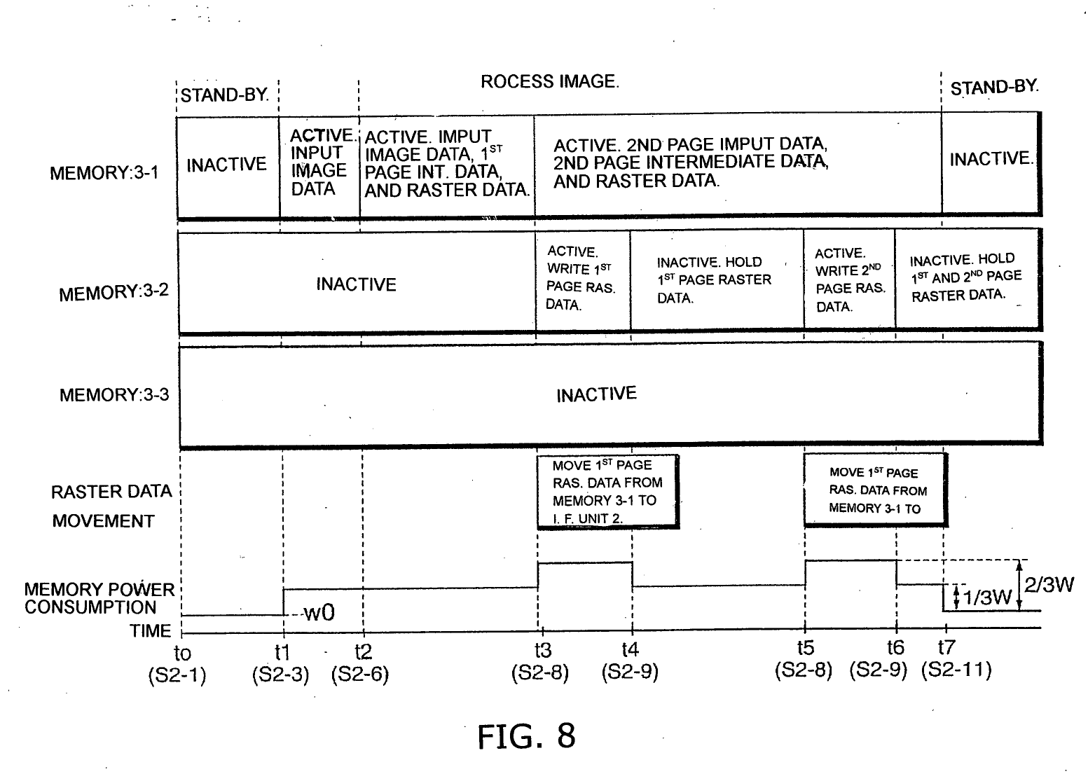

The power consumption of the image process unit according to the second embodiment will be described with reference to FIG. 8, wherein the state description, state of the memory sections 3-1, 3-2, and 3-3, movement of the raster data, and memory power consumption are given along the vertical axis and the time and the steps in FIG. 7 are given along the horizontal axis. It is assumed that there are two pages of image data to be reproduced and that the memory capacity necessary for processing the image data does not exceed one memory section.

At a time t0, the image processing unit 21 stands by for receiving the image data 10 from the preceding device 5. This is the state of Step S2-1. Under this condition, the memory sections 3-1, 3-2, and 3-3 receive a low level CKE signal and remain at the inactive state. Consequently, the memory power consumption of the image processing unit 21 is WO watts.

At a time t1, the image processing unit 21 receives the image data, and the control section 14 sends a high level CKE signal to the memory section 3-1 to secure the memory area necessary for storing the image data 10. This is the state of Step S2-3. The memory section 3-1 receives the high level CKE signal and switches to the active state. The memory sections 3-2 and 3-3, however, stay in the inactive state. Consequently, the memory power consumption increases only ⅓ W watts in contrast to the conventional image processing unit wherein all the memory sections switch to the active state, increasing the memory power consumption by W watts.

At a time t2, based on the data quantity of a page of raster data determined in Step S2-5, the control section 14 determines the memory section area necessary for the image process and sends a high level CKE signal to the memory section to secure the necessary memory area. This is the state of Step S2-6. Under the above condition, the necessary memory capacity is small that the memory section 3-1 alone is sufficient, and the other memory sections 3-2 and 3-3 remain in the inactive state. Consequently, the memory power consumption remains at (W0+⅓ W) watts.

At a time t3, the control section 14 completes the generation of the first page of raster data and starts sending the raster data to the image forming unit 2. Also, it sends a high level CKE signal to the memory section 3-2 for activation and starts storing the first page of raster data in the memory section 3-2. At the same time, it uses the vacant area of the memory section 3-1 to start receiving and processing the second page of image data. Under this condition, the memory sections 3-1 and 3-2 are in the active state so that the memory power consumption is (W0+⅔ W) watts.

At a time t4, when the first page of raster data is stored in the memory section 3-2, the control section 14 sends a low level CKE signal to the memory section 3-2, bringing it into the inactive state. This holds the first page of raster data for reproduced image in the memory section 3-2 in the power down mode. Simultaneously, the memory section 3-1 is kept in the active state because the control section 14 has started processing the second page. Consequently, the memory power consumption becomes (W0+⅓ W) watts. This is the state of Step S2-9. The first page of rater data is kept until it is reproduced on paper in the image forming unit 2. Thus, it is possible to deal with the paper jam in the image forming section 2.

At a time t5, the control section 14 completes the image process of the second page and sends not only the second page of raster data to the image forming unit 2 but also a high level CKE signal to the memory section 3-2 for activation to start storing the second page of raster data. Under this condition, both the memory sections 3-1 and 3-2 are in the active state so that the memory power consumption becomes (W0+⅔ W) watts. This is the state where Step S2-7 are repeated twice to reach Step S2-8.

At a time t6, when the second page of raster data is stored in the memory section 3-2, the control section 14 sends a low level CKE signal to the memory section 3-2, bringing it to the inactive state. This holds the first and second pages of raster data for the reproduced image in the memory section 3-2 in the power down mode. Under this condition, the transmission of the second page of raster data to the image forming unit 2 is not completed. Consequently, the memory section 3-1 is in the active state so that the memory power consumption is (W0+⅓ W) watts. This is the state where the Step S2-7 is repeated twice to reach Step S2-9. The first and second pages of raster data are kept in the memory section 3-2 until they are reproduced on paper in the image forming unit 2. Thus, it is possible to deal with the paper jam in the image forming unit 2.

At a time t7, when all of the second page of raster data is sent to the image forming unit 2, the control section 14 sends a low level CKE signal to all the memory sections, switching them to the inactive state and stands by for receiving image signals. This is the state of Step S2-11.

The page data quantity determining section 14-1, the memory section area determining section 14-2, the memory state setting section 14-3, and the post data holding section of the control section 14 are related in software to the this embodiment in the following manner.

The page data quantity determining section 14-1 determines the image data quantity necessary for acquiring a page of reproduced image from the received image attribute information and corresponds to the step S1-4 wherein the control section 14 abstracts only the image attribute data 10-1 from the image data 10 and the step S2-5 wherein the memory capacity necessary for image process of the page of reproduced image is determined based on the image attribute data 10-1.

The memory section area determining section 14-2 determines the memory section area necessary for acquiring a page of reproduced image based on the determination result of the page data quantity determining section 14-1 and corresponds to a module for the step S1-5 wherein the control section 14 determines the memory section area necessary for the image process in the step S1-4.

The memory state setting section 14-3 sets a plurality of memory sections in either active or inactive state and corresponds to a module of the step S2-3 wherein when the control section 14 receives the image data 10 from the preceding device 5 (Step 2-2), it sends a high level CKE signal to the memory section 3-1 (Step S2-3). Also, it corresponds to a module of the step S2-6 wherein based on the determination result of the memory section area determining section 14-2, the memory section 3-1 sends a high level CKE signal to the predetermined memory section for activation. Further, it corresponds to a module wherein when the image process is completed (Step S2-8), it sends a low lever CKE signal to all the memory sections, bringing them to the inactive state.

The post data holding section 14-4 corresponds to a module wherein the control section 14 sends a high level CKE signal to the memory section 3-2 for activation to store the raster data for a page of reproduced image in the step S2-8 and, when the storage is completed, sends a low level CKE signal to switch the memory section 3-2 to the inactive state in the step S2-9.

Alternatively, the number of memory sections may be any plural number. The SDRAMs, which hold data in the inactive state, may be replaced by any memory that holds data until the image forming unit 2 discharges the last paper sheet. For example, a memory with no data holding function may be used by keeping power on for the memory to keep the data. The page data quantity determining section 14-1, the memory section area determining section 14-2, the memory state setting section 14-3, and the post data holding section 14-4 are made as a computer program for controlling the control section 14 but may be made circuit blocks having auxiliary functions of the control section 14.

As has been described above, according to the second embodiment, the control section 14 comprises the page data quantity determining section 14-1, the memory section area determining section 14-2, the memory state setting section 14-3, and the post data holding section 14-4 to minimize the power consumption during the image process even in the apparatus that requires temporarily holding a plurality of pages of raster data corresponding to the paper running route.

1. An image processing apparatus for processing image information containing image attribute information, comprising:
at least one memory section that is set independently in either active or inactive state;
a data quantity determining section for determining a data quantity of said image information based on said image attribute information;
a memory section area determining section for determining a necessary memory section area based on a determination result of said data quantity determining section; and
a memory state setting section for setting said memory section in either said active or said inactive state based on a determination result of said memory section area determining section.

2. The image processing apparatus according to claim 1, wherein said data quantity determining section determines a raster data quantity acquired from said image information.

3. The image processing apparatus according to claim 1, wherein said image attribute information contains resolution information of said image data.

4. The image processing apparatus according to claim 1, wherein said image attribute information contains gradient information of said printing data.

5. The image processing apparatus according to claim 1, wherein said memory section is a synchronous dynamic random access memory (SDRAM), said memory state setting section sends a clock enable (CKE) signal to said SDRAM to set a state thereof, and said inactive state is a state where said SDRAM is in a power down mode.

6. An image forming apparatus including an image processing unit for processing image information containing image attribute information received and an image forming unit for forming an image based on image data processed by said image processing unit, wherein said image processing unit comprising:
at least one memory section that independently is set in either active or inactive state;
a data quantity determining section for determining a data quantity of said image information based on said image attribute information;
a memory section area determining section for determining a necessary memory section area based on a determination result of said data quantity determining section; and
a memory state setting section for setting said memory section at either said active or said inactive state based on a determination result of said memory section area determining section.

7. The image forming apparatus according to claim 6, wherein said image attribute information contains medium size information about a printing medium on which printing is made by said image forming unit.

8. The image forming apparatus according to claim 6, wherein said image attribute information contains printing designation information for designating either single or both side printing on a printing medium on which printing is made by said image forming unit.

9. The image forming apparatus according to claim 6, wherein said image processing unit further comprises:
a post data holding section for activating a part of said inactive memory section after raster data for a page of image to be formed by said image forming unit is sent to said image forming unit, and stores said raster data in said activated memory section, and setting again said activated memory section in said inactive state;
said data quantity determining section determines a data quantity necessary for acquiring a page of reproduced image based on said image attribute information; and
said memory section area determining section determines a memory section area necessary for processing raster data for a page of said reproduced image.

10. The image forming apparatus according to claim 9, wherein said post data holding section for holding raster data in said inactive memory section until a printing medium on which said raster data is printed is discharged after said raster data for a page of said reproduced image is sent to said image forming unit.
